(19) United States
(12) Patent Application Publication
(10) Pub. No.: US 2026/0079961 A1
(43) Pub. Date: Mar. 19, 2026

(54) SYSTEMS AND METHODS FOR METADATA GENERATION AND SYNCHRONIZATION FOR INTERACTIVE DATA EXPLORATION

(71) Applicant: Salesforce, Inc., San Francisco, CA (US)

(72) Inventors: Anantharaman GANESH, San Jose, CA (US); Ravishankar ARIVAZHAGAN, Union City, CA (US); Sreeram Kumar GARLAPATI, Bothell, CA (US); Srinivas TIRUPATI, Bothell, WA (US); Christopher LAMBACHER, Burlington (CA)

(21) Appl. No.: 19/043,378

(22) Filed: Jan. 31, 2025

Related U.S. Application Data
(60) Provisional application No. 63/695,295, filed on Sep. 16, 2024.

(51) Int. Cl. G06F 16/27; G06F 16/23

(52) U.S. Cl. CPC G06F 16/27; G06F 16/2365; G06F 16/2379

(57) ABSTRACT

A metadata synchronization system enables real-time interactive data exploration through a distributed metadata architecture. The system propagates metadata updates through an event-based synchronization path that maintains metadata consistency across system components. For discovered data sources, the system concurrently manages metadata in primary and secondary services instead of following traditional batch synchronization. A primary metadata service generates and manages metadata definitions while an event bus component propagates metadata update events to a secondary service maintaining a local metadata store. A query service provides immediate access to metadata for data exploration operations. In some implementations, the event bus components enables near-rime metadata availability. In some implementations, the secondary metadata service processes direct metadata updates and maintains metadata states prior to synchronization with the primary metadata service. The system reduces metadata access latency by eliminating batch synchronization overhead, enables immediate data exploration through coordinated metadata management, and maintains consistency through stateful task tracking.

### RELATED APPLICATIONS

This application claims priority to U.S. Provisional Application Ser. No. 63/695,295, filed Sep. 16, 2024, entitled “Self-Service Interactive Metadata,” which is incorporated by reference herein in its entirety.

### TECHNICAL FIELD

The disclosed implementations relate generally to interactive computing environments and more specifically to systems, methods, and architectures that enable metadata generation and synchronization across system components for interactive data exploration applications.

### BACKGROUND

In distributed computing environments, organizations face significant technical challenges when discovering and representing data structures from various sources for interactive exploration. Systems must solve the complex problem of inferring and generating metadata structures within strict latency constraints (e.g., 100 milliseconds for inference and 500 milliseconds for availability), while simultaneously maintaining consistent metadata representations across distributed components to enable near real-time querying. These systems need to process schemas from diverse sources including CSV files, multi-sheet Excel documents, databases, and SaaS applications, all while maintaining a consistent metadata representation. The challenge is compounded by strict performance requirements, as systems must handle thousands of data lake objects and data streams while maintaining sub-second response times for metadata operations. This creates a fundamental tension between the need for rapid metadata availability in distributed components and the requirement to maintain consistent, accurate metadata representation across the system for interactive data exploration.

### SUMMARY

There is a need for a metadata management system that can efficiently handle real-time data exploration scenarios while maintaining metadata consistency across distributed system components. The disclosed system solves the problem of slow metadata availability by introducing a synchronized architecture that intelligently manages metadata across system boundaries. For data tables discovered through file uploads or external connections, the system processes metadata through a rapid synchronization path that propagates changes across components within milliseconds, rather than waiting for traditional batch synchronization cycles. This fast path uses a specialized metadata service that directly creates and synchronizes metadata representations without the overhead of sequential processing, while maintaining compatibility with existing metadata management systems. In some implementations, the system includes a metadata discovery component that automatically infers schema information, asynchronization controller that manages metadata propagation across components, a state management system that tracks metadata availability, and/or a unified query interface that provides consistent metadata access. This architecture enables analysts to start exploring their datasets within milliseconds of discovery while maintaining robust metadata management capabilities across the system.

The disclosed system provides several technical improvements over conventional metadata management systems. For example, the system reduces latency by eliminating the need for batch-based metadata synchronization, instead using a lightweight synchronization service that achieves the same consistency with significantly less delay. Also, the coordinated processing of metadata across components reduces overall system latency (e.g., to under 500 milliseconds) for newly discovered tables, achieved through state management that maintains consistency without requiring traditional replication cycles. Furthermore, the system improves exploration efficiency by coordinating metadata availability across components before query processing begins, eliminating the need for metadata revalidation and reducing operational overhead.

Additional technical benefits include reduced system complexity through unified metadata handling, improved system scalability through independent metadata management across components, and/or enhanced system reliability through stateful task management that enables precise tracking of metadata synchronization. The system's unified metadata interface also reduces application complexity by abstracting the underlying synchronization mechanisms, resulting in simplified client implementations and reduced maintenance overhead. These improvements are achieved through specific technical implementations rather than merely following conventional approaches at a higher speed.

In accordance with some implementations, a metadata synchronization system includes a primary metadata service, an event bus component, a secondary metadata service, and a query service. The primary metadata service is configured to receive data source connection requests, generate metadata for discovered data sources, and generate metadata update events. The event bus component is configured to propagate the metadata update events to subscribing services within a predefined latency threshold. The secondary metadata service is configured to maintain a local metadata store for interactive query operations. The secondary metadata service is also configured to update the local metadata store based on received metadata update events. The query service is configured to enable data exploration operations using the local metadata store within a predetermined time (e.g., 500 milliseconds) of data source discovery. The event bus component, in some implementations, enables near real-time metadata availability for interactive data exploration while maintaining metadata consistency across the services.

In some implementations, the secondary metadata service is further configured to obtain and/or process direct metadata updates and maintain draft metadata states prior to synchronization with the primary metadata service.

In some implementations, the metadata synchronization system includes a state management component configured to track metadata states including path reserved, commit pending, overwrite success, and overwrite failure.

In some implementations, the primary metadata service is further configured to complete schema inferencing for each table within a predetermined time.

In some implementations, the primary metadata service is further configured to process multiple sheets from spreadsheet files and create separate metadata definitions for each table.

In some implementations, the primary metadata service is further configured to maintain a single metadata definition with non-parseable status for sheets that fail schema inference.

In some implementations, the metadata synchronization system includes a task state machine configured to track metadata discovery and synchronization across system restarts.

In some implementations, the system is further configured to maintain separate metadata stores for personal exploration workspaces disconnected from main organization metadata.

In some implementations, the system is further configured to maintain metadata consistency through background synchronization when event-based propagation fails.

In some implementations, the event bus component is further configured to guarantee event delivery only for successfully committed metadata transactions.

In some implementations, the primary metadata service is further configured to create data stream definitions associated with discovered metadata for data ingestion tracking.

In some implementations, the query service is further configured to obtain security filter predicates from the local metadata store for each table referenced in queries.

In some implementations, the system is further configured to maintain cross-references between visualizations, semantic models, data lake objects, and data streams for lineage tracking.

In some implementations, the primary metadata service is further configured to process metadata discovery requests using a connection identifier and an optional file identifier for different data source types.

In some implementations, the system is further configured to track metadata synchronization status through synchronized state transitions for each table definition.

In some implementations, the query service is further configured to resolve semantic data models using metadata from the local metadata store.

In some implementations, the primary metadata service is further configured to manage data lake objects, data model objects, and semantic data models as distinct metadata types.

In some implementations, the primary data service is further configured to validate access using OAuth tokens, the secondary metadata service is further configured to validate access using claims embedded within data cloud tokens, and the system is further configured to require both OAuth token validation for operations of the primary metadata service and claim validation from data cloud tokens for operations of the secondary metadata service.

In some implementations, the system is further configured to re-run metadata discovery operations for tasks in a discover state after system restarts.

In some implementations, the system is further configured to maintain metadata isolation across different organization and tenant boundaries.

In some implementations, the system further includes a connector service configured to provide schema preview capabilities while metadata discovery is in progress.

In some implementations, wherein the system is further configured to prevent direct service calls during database transactions.

In some implementations, the primary metadata service is further configured to manage temporary credentials for accessing data sources during metadata discovery operations.

In accordance with some implementations, a method is performed by a metadata synchronization system, which includes a primary metadata service, an event bus component, a secondary metadata service, and a query service. The primary metadata service receives data source connection requests, generates metadata for discovered data sources, and/or generates metadata update events. The event bus component propagates the metadata update events to subscribing services within a predefined latency threshold. The secondary metadata service maintains a local metadata store for interactive query operations. The secondary metadata service also updates the local metadata store based on received metadata update events. The query service enables data exploration operations using the local metadata store within a predetermined time (e.g., 500 milliseconds) of data source discovery. The event bus component, in some implementations, enables near real-time metadata availability for interactive data exploration while maintaining metadata consistency across the services.

In some implementations, the secondary metadata service further obtains and/or processed direct metadata updates and maintains draft metadata states prior to synchronization with the primary metadata service.

In some implementations, the metadata synchronization system includes a state management component that tracks metadata states including path reserved, commit pending, overwrite success, and overwrite failure.

In some implementations, the primary metadata service further completes schema inferencing for each table within a predetermined time.

In some implementations, the primary metadata service further processes multiple sheets from spreadsheet files and create separate metadata definitions for each table.

In some implementations, the primary metadata service further maintains a single metadata definition with non-parseable status for sheets that fail schema inference.

In some implementations, the metadata synchronization system includes a task state machine that tracks metadata discovery and synchronization across system restarts.

In some implementations, the system further maintains separate metadata stores for personal exploration workspaces disconnected from main organization metadata.

In some implementations, the system further maintains metadata consistency through background synchronization when event-based propagation fails.

In some implementations, the event bus component further guarantees event delivery only for successfully committed metadata transactions.

In some implementations, the primary metadata service further creates data stream definitions associated with discovered metadata for data ingestion tracking.

In some implementations, the query service further obtains security filter predicates from the local metadata store for each table referenced in queries.

In some implementations, the system further maintains cross-references between visualizations, semantic models, data lake objects, and data streams for lineage tracking.

In some implementations, the primary metadata service further processes metadata discovery requests using a connection identifier and an optional file identifier for different data source types.

In some implementations, the system further tracks metadata synchronization status through synchronized state transitions for each table definition.

In some implementations, the query service further resolves semantic data models using metadata from the local metadata store.

In some implementations, the primary metadata service further manages data lake objects, data model objects, and semantic data models as distinct metadata types.

In some implementations, the primary data service further validates access using OAuth tokens, the secondary metadata service validates access using claims embedded within data cloud tokens, and the system requires both OAuth token validation for operations of the primary metadata service and claim validation from data cloud tokens for operations of the secondary metadata service.

In some implementations, the system further re-runs metadata discovery operations for tasks in a discover state after system restarts.

In some implementations, the system further maintains metadata isolation across different organization and tenant boundaries.

In some implementations, the system further includes a connector service configured to provide schema preview capabilities while metadata discovery is in progress.

In some implementations, wherein the system prevents direct service calls during database transactions.

In some implementations, the primary metadata service further manages temporary credentials for accessing data sources during metadata discovery operations.

Typically, an electronic device includes one or more processors, memory, a display, and one or more programs stored in the memory. The programs are configured for execution by the one or more processors and are configured to perform any of the methods described herein.

In some implementations, a non-transitory computer-readable storage medium stores one or more programs configured for execution by a computing device having one or more processors, and memory. The one or more programs are configured to perform any of the methods described herein.

Thus, methods and systems are disclosed that allow rapid interactive data exploration through a synchronized metadata architecture, accomplished by automatic schema discovery, near real-time metadata synchronization across distributed components, intelligent state management of metadata propagation, and unified metadata access across system boundaries, resulting in sub-second metadata availability while maintaining consistency and reliability across the system.

Both the foregoing general description and the following detailed description are exemplary and explanatory and are intended to provide further explanation of the invention as claimed.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Description of Implementations below, in conjunction with the following drawings in which like reference numerals refer to corresponding parts throughout the figures.

FIG. 1 is a block diagram of an example system for metadata generation and synchronization for interactive data exploration, according to some implementations.

FIG. 2 is a sequence diagram of a first example process for metadata generation and synchronization for interactive data exploration, according to some implementations.

FIG. 3 is a sequence diagram of a second example process for metadata generation and synchronization for interactive data exploration, according to some implementations.

FIG. 4 is a sequence diagram of a third example process for metadata generation and synchronization for interactive data exploration, according to some implementations.

FIG. 5 is a sequence diagram of a fourth example process for metadata generation and synchronization for interactive data exploration, according to some implementations.

FIG. 6 is a block diagram of an example computing device for metadata generation and synchronization for interactive data exploration, according to some implementations.

FIG. 7 is a flowchart of an example method for metadata generation and synchronization, according to some implementations.

FIG. 8 is a flowchart of another example method for metadata generation and synchronization, according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

The various methods and devices disclosed in the present specification improve the efficiency and performance of data ingestion systems by reducing computational overhead through selective processing paths, eliminating sequential processing bottlenecks through concurrent metadata and data handling, and/or enabling immediate data querying through coordinated storage management, thereby advancing the technical field of distributed data processing systems beyond conventional batch-oriented architectures.

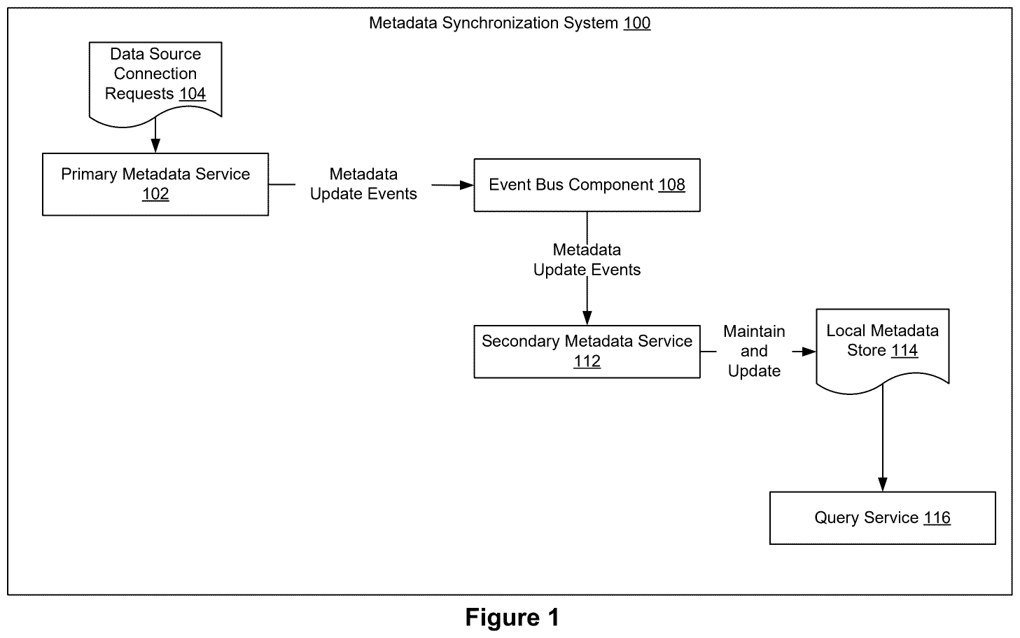

FIG. 1 is a block diagram of an example system 100 for metadata generation and synchronization for interactive data exploration, according to some implementations. The system enables rapid metadata availability and consistency across distributed components through an event-driven architecture. A primary metadata service 102 serves as the entry point, receiving data source connection requests 104 and performing initial metadata processing. Upon processing, the primary metadata service 102 generates metadata update events that are propagated through the event bus component 108, which acts as a high-performance message broker ensuring prompt delivery (e.g., sub-second delivery) to subscribing services. The secondary metadata service 112 receives these events and maintains a local metadata store 114 that stays synchronized with the primary service. The store 114 provides fast access to metadata for a query service 116, enabling data exploration operations within a short duration (e.g., 500 milliseconds) of data discovery.

In some implementations, the system's entry point (for the data source connection requests 104) is managed through a connect application programming interface (API) that interfaces with the primary metadata service. To ensure reliability across system interruptions, in some implementations, this connect API implements a task state machine that handles both core application server restarts and browser restarts. In some implementations, the API uses a connection identifier for authentication, as credentials are associated with specific connections. When working with file-based data sources, an additional file identifier may be used to specify which file(s) should be accessed through the established connection.

For data lake objects (DLOs), the system 100 maintains real-time synchronization between the primary metadata service 102 (sometimes referred to as the core metadata service or MDS) and the secondary metadata service 112 (sometimes referred to as near-core components). This synchronization enables ad-hoc exploration capabilities in analytics frameworks (e.g., Tableau Unified Analytics (TUA)), allowing users to interact with data immediately after discovery. A semantic engine operates in the near-core environment (the architectural zone where the secondary metadata service 112 operates), interfacing with the primary metadata service 102 to process semantic queries. When working with semantic data models (SDMs), the semantic engine resolves references to both DLOs and data model objects (DMOs), translating these into executable queries for the query service 116 (sometimes referred to as Hyper).

In some implementations, security is maintained throughout the query process, with the query service 116 requesting security filter predicates from the primary metadata service 102 through an API for the query service 116. These predicates are applied to ensure appropriate access controls for each DLO referenced in queries. In some implementations, the query service 116 operates in the near-core environment, where the semantic engine processes structured queries by requesting DLO information from the primary metadata service 102. In some implementations, the system 100 supports auto-discoverable tables that can be used in both semantic and structured queries. For uploaded files, the system 100 includes a data ingestion process that moves data into a Lakehouse or a similar data architecture that combines features of data lakes and data warehouses, making it available for queries through a defined data stream.

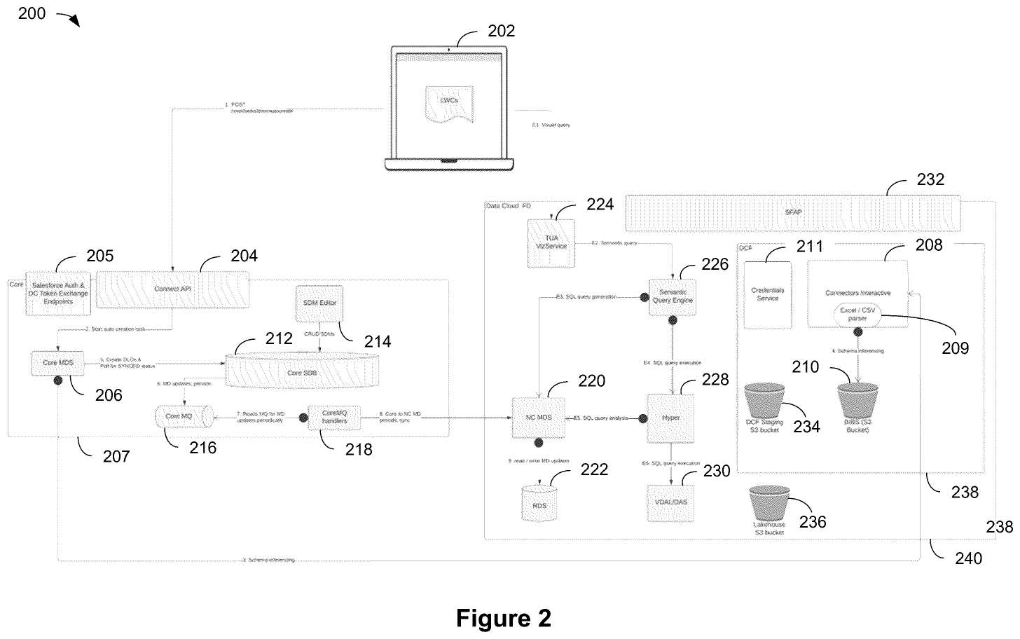

FIG. 2 is a schematic diagram of an example batch synchronization implementation 200 of the FIG. 1 architecture, according to some implementations. A core MDS 206 acts as the primary metadata service 102, core message queue (MQ) 216 and core MQ handlers 218 implement the event bus component 108 functionality, and near-core MDS 220 serves as the secondary metadata service 112. This implementation shows how the local metadata store 114 in FIG. 1 can be realized through a relational database service (RDS) 222. The process shown in FIG. 2 corresponds to metadata generation and synchronization using a batch-oriented approach. The process begins when a computer system 202, through its lightning web component, initiates an auto-create task via the connect API 204. This triggers a sequence of metadata discovery and synchronization operations across multiple system components. The metadata discovery phase starts with the connect API 204 forwarding the request to the core MDS 206, which coordinates schema inferencing through interactive connectors 208. An Excel/CSV parser 209 performs schema analysis on data stored in BIBS 210 (S3 bucket) and returns the inferred schema back to core MDS 206. Upon receiving the schema, core MDS 206 creates corresponding data lake objects (DLOs) and monitors their synchronization status through core store database (SDB) 212. This process enables metadata creation and initial synchronization.

In some implementations, the metadata synchronization flow then continues through one or more stages. For example, the core SDB 212 receives semantic data model (SDM) updates from the SDM editor 214 and periodically pushes metadata updates to core MQ 216. The Core MQ handlers 218 monitor these updates and facilitate synchronization with near-core MDS 220, which persists the metadata in RDS 222. This batch synchronization pattern ensures eventual consistency of metadata across the system.

For query processing, the system 200 supports interactive data exploration through visual queries. In some implementations, when the computer system 202 requests a visualization, the TUA VizService 224 coordinates with the semantic query engine 226 to generate and execute structured queries. The semantic query engine 226 interacts with near-core MDS 220 for query generation and works with Hyper 228 for query execution. Hyper 228 performs structured query analysis through near-core MDS 220 before executing the query via VDAL/DAS 230.

In some implementations, as shown in FIG. 2, the system components are distributed across three main boundaries for optimal performance and security: (i) a core 207 houses the authentication services, connect API 204, core MDS 206, core SDB 212, SDM editor 214, and message queue components; (ii) DCF 238 contains the interactive connectors 208, parsers 209, storage services (BIBS 210), and credentials management; and (iii) data cloud FD 240 manages query processing components including SFAP 232, TUA VizService 224, semantic query engine 226, near-core MDS 220, RDS 222, Hyper 228, and VDAL/DAS 230. This architecture enables efficient metadata synchronization while maintaining clear separation of concerns across different system boundaries.

FIG. 2 also illustrates an example process (as shown by the steps along the connecting arrows) for metadata generation and synchronization for interactive data exploration, according to some implementations. In some implementations, a computer system 202 posts a request associated with an auto create task to the connect API 204. The request may be posted via a lightning web component of the computer system 202. The connect API 204 sends a request to start the auto creation task at a core MDS 206. The core MDS 206 sends a schema inferencing request to the interactive connectors 208, which may include an Excel and/or CSV parser 209. The Excel and/or CSV parser 209 performs the schema inferencing based on data from a BIBS 210 (e.g., S3 bucket). In response to successful completion of the schema inferencing request, the Excel and/or CSV parser 209 returns the inferred schema (e.g., a token, metadata, and or data payload) to the core MDS 206. The core MDS 206 creates DLOs, and polls SYNCED status from a core SDB 212. The SDM editor 214 sends CRUD SDMs to the core SDB 212. The core SDB 212 sends periodic MD updates to the core MQ 216. Core MQ handlers 218 reads core MQ 216 periodically for MD updates. In response to an MD update at the core MQ 216, the core MQ 216 returns the MD update (e.g., a token, metadata, and or data payload) to the core MQ handlers 218. The core MQ handlers periodically synchronize with a near-core MDS 220 that reads and/or writes the MD updates to RDS 222.

In some implementations, the computer system 202 requests a visual query from a TUA VizService 224. The TUA VizService 224 requests a semantic query from semantic query engine 226. The semantic query engine 226 requests structured query generation from the near-core MDS 220 which returns a generated structured query to the semantic query engine 226. The semantic query engine 226 sends the generated structured query and requests execution of the generated structured query to Hyper 228. Hyper 228 requests structured query analysis from the near-core MDS 220, and the near-core MDS 220 returns an analysis of the generated structured query. Hyper 228 then requests execution of the structured query from VDAL/DAS 230.

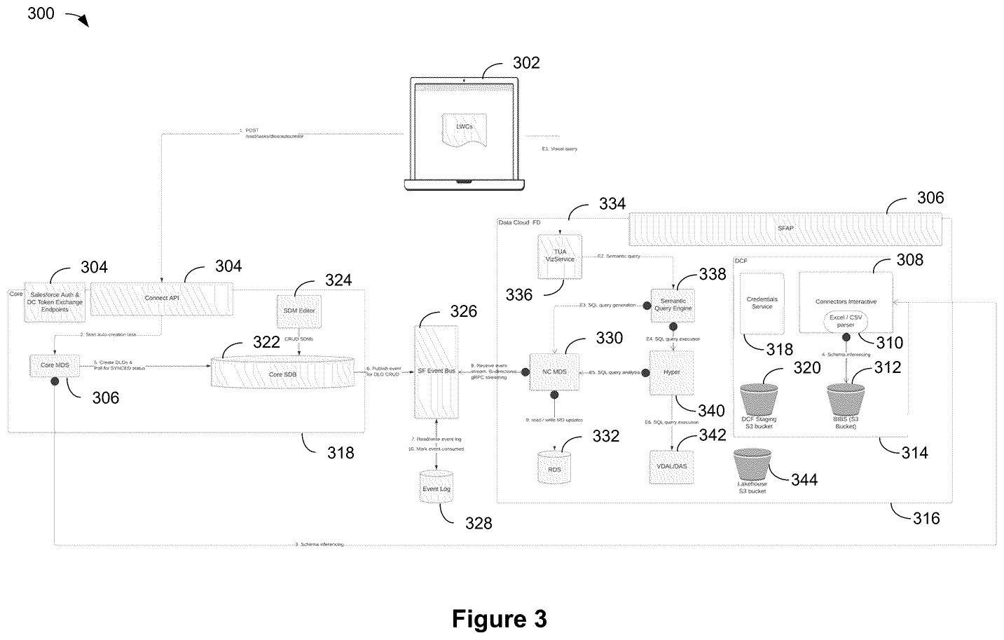

FIG. 3 is a schematic diagram of an example event-driven implementation 300 of the FIG. 1 architecture, according to some implementations. A core MDS 306 functions as the primary metadata service 102, event bus 326 implements the event bus component 108, and near-core MDS 330 operates as the secondary metadata service 112. This demonstrates a real-time event propagation approach to maintaining the local metadata store 114 in FIG. 1 through RDS 332. FIG. 3 also illustrates an example process for metadata generation and synchronization for interactive data exploration, according to some implementations. In some implementations, a computer system 302 posts a request associated with an auto create task to connect API 304. The request may be posted via a lightning web component of the computer system 302.

The connect API 304 sends a request to start the auto creation task at a core MDS 306. The core MDS 306 sends a schema inferencing request to the interactive connectors 308, which includes an Excel and/or CSV parser 310. The Excel and/or CSV parser 310 performs the schema inferencing based on data from a BIBS 210 (e.g., S3 bucket). In response to successful completion of the schema inferencing request, the Excel and/or CSV parser 310 returns the inferred schema (e.g., a token, metadata, and or data payload) to the core MDS 306. The core MDS 306 creates DLOs, and polls SYNCED status from a core SDB 322. The core SDB 322 sends a publish event request for DLO CRUD to the event bus 326. The event bus 326 reads and/or writes to an event log 328 in response to the publish event. A near-core MDS 330 receives the publish event. In some implementations, the near-core MDS 330 receives the event stream via bi-directional streaming. The near-core MDS reads and/or writes MD updates to RDS 332. In response to a successful read and/or write of the MD updates to RDS 322, the event bus 326 marks the event as consumed in event log 328.

In some implementations, the computer system 302 requests a visual query from a TUA VizService 334. The TUA VizService 334 requests a semantic query from semantic query engine 338. The semantic query engine 338 requests structured query generation from the near-core MDS 330 which returns a generated structured query to the semantic query engine 338. The semantic query engine 338 sends the generated structured query and requests execution of the generated structured query to Hyper 340. Hyper 340 requests structured query analysis from the near-core MDS 330, and the near-core MDS 330 returns an analysis of the generated structured query. Hyper 340 then requests execution of the structured query from VDAL/DAS 342.

In some implementations, authentication, and DC token exchange endpoints 304, connect API 304, core MDS 306, core SDB 322, SDM editor 324, reside in a core 318. In some implementations, the interactive connectors 308, Excel and/or CSV parser 310, BIBS 312, credentials service 318, and DCF staging S3 bucket 320 reside in a DCF 238. In some embodiments, the SFAP 306, TUA VizService 336, semantic query engine 338, near-core MDS 330, RDS 332, Hyper 340, VDAL/DAS 342, DCF 314, and Lakehouse S3 bucket 344 reside in a data cloud FD 334.

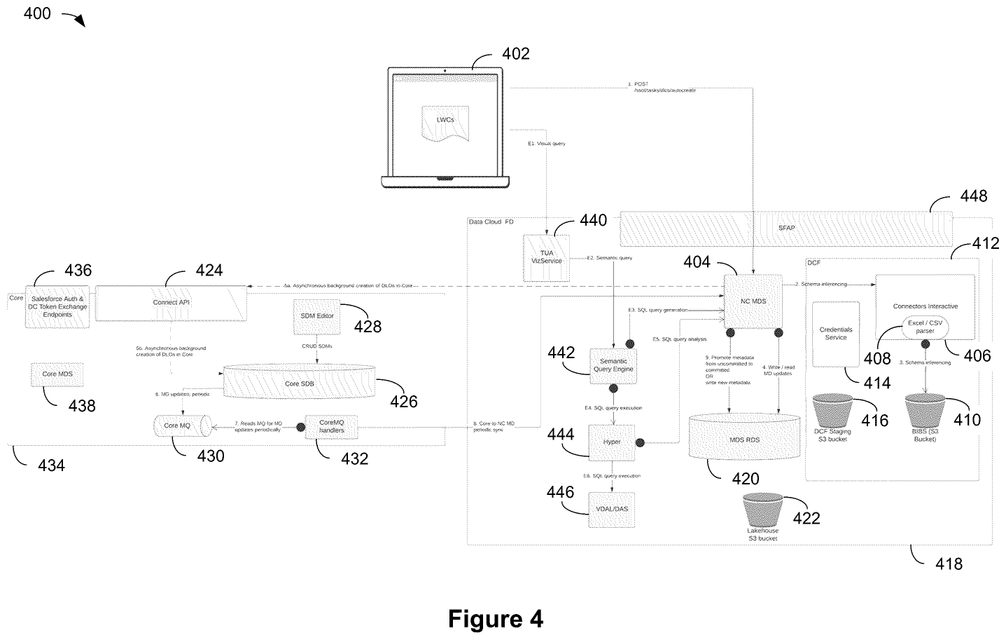

FIG. 4 is a schematic diagram of an example near-core initiated implementation 400 of the FIG. 1 architecture, according to some implementations. Near-core MDS 404 combines aspects of both the primary metadata service 102 and secondary metadata service 112, with asynchronous updates to core 434. This implementation demonstrates how the local metadata store (104 in FIG. 1) can be maintained in MDS RDS 420 while still ensuring consistency with the core system. FIG. 4 also illustrates an example process for metadata generation and synchronization for interactive data exploration, according to some implementations. In some implementations, a computer system 402 posts a request associated with an auto create task to near-core MDS 404. The request may be posted via a lightning web component of the computer system 202. The near-core MDS 404 sends a schema inferencing request to the interactive connectors 406, which includes an Excel and/or CSV parser 408. The Excel and/or CSV parser 408 performs the schema inferencing based on data from a BIBS 410 (e.g., S3 bucket).

In response to successful completion of the schema inferencing request, the Excel and/or CSV parser 408 returns the inferred schema (e.g., a token, metadata, and or data payload) to the near-core MDS 404. The near-core MDS reads and/or writes MD updates to MDS RDS 420. The near-core MDS 404 requests asynchronous background creation of DLOs in core 434 via connect API 424. The connect API 424 sends a request for asynchronous background creation of DLOs in core-to-core SDB 426. The SDM editor 428 sends CRUD SDMs to the core SDB 426. The core SDB 426 sends periodic MD updates to the core MQ 430. Core MQ handlers 432 reads core MQ 430 periodically for MD updates. The core MQ handlers 432 periodically synchronize with a near-core MDS 220 that promotes metadata from uncommitted to committed in, or writes new metadata to, MDS RDS 420.

In some implementations, the computer system 402 requests a visual query from a TUA VizService 440. The TUA VizService 440 requests a semantic query from semantic query engine 442. The semantic query engine 442 requests structured query generation from the near-core MDS 404 which returns a generated structured query to the semantic query engine 442. The semantic query engine 442 sends the generated structured query and requests execution of the generated structured query to Hyper 444. Hyper 444 requests structured query analysis from the near-core MDS 404, and the near-core MDS 404 returns an analysis of the generated structured query. Hyper 444 then requests execution of the structured query from VDAL/DAS 446.

In some implementations, authentication, and DC token exchange endpoints 436, connect API 424, core MDS 438, core SDB 426, SDM editor 428, core MQ 430, and core MQ handlers 432 reside in a core 434. In some implementations, the interactive connectors 406, Excel and/or CSV parser 408, BIBS 410, credentials service 414, and DCF staging S3 bucket 416 reside in a DCF 412. In some embodiments, the SFAP 448, TUA VizService 440, semantic query engine 442, near-core MDS 404, MDS RDS 420, Hyper 444, VDAL/DAS 446, DCF 412, and Lakehouse S3 bucket 422 reside in a data cloud FD 334.

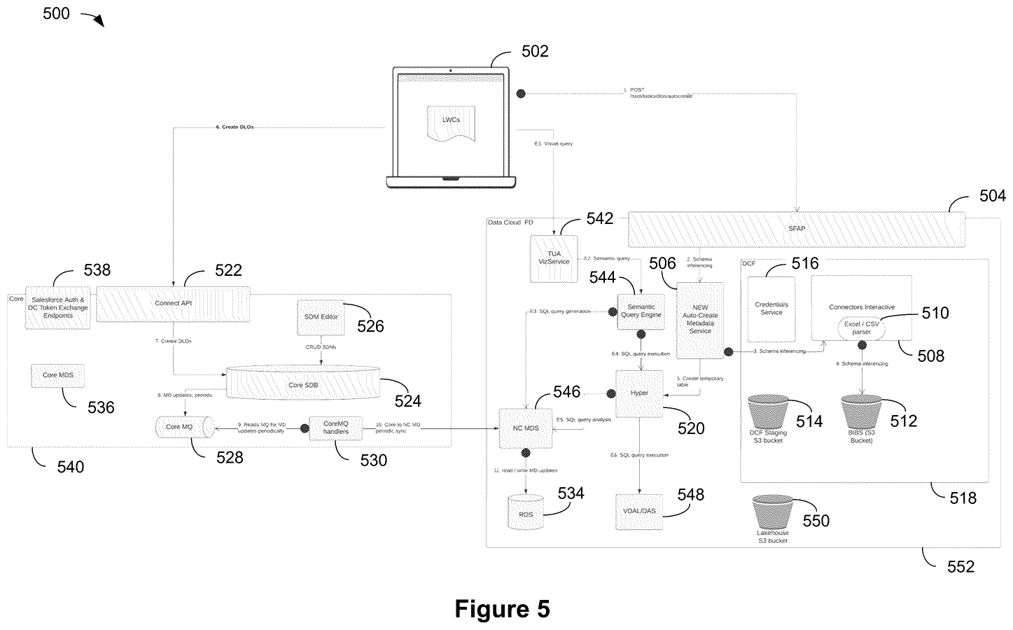

FIG. 5 is a schematic diagram of an example metadata creation service implementation 500 of the FIG. 1 architecture, according to some implementations. Metadata creation service 506 extends the primary metadata service 102 functionality, with near-core MDS 546 implementing the secondary metadata service 112 capabilities. This implementation shows how temporary metadata can be managed while maintaining the core synchronization principles established in FIG. 1. FIG. 5 also illustrates an example process for metadata generation and synchronization for interactive data exploration, according to some implementations. In some implementations, a computer system 502 posts a request associated with an auto create task to SFAP 504. The request may be posted via a lightning web component of the computer system 502. The connect SFAP 504 sends a schema inferencing request to a metadata creation service 506. The metadata creation service 506 sends the schema inferencing request to interactive connectors 508, which includes an Excel and/or CSV parser 510. The Excel and/or CSV parser 510 performs the schema inferencing based on data from a BIBS 512 (e.g., S3 bucket).

In response to successful completion of the schema inferencing request, the Excel and/or CSV parser 510 returns the inferred schema (e.g., a token, metadata, and or data payload) to the metadata creation service 506. The metadata creation service requests creation of a temporary table by Hyper 520. The computer system 502 sends a request for creation of DLOs to connect API 522. The connect API 522 sends a request to create DLOs to core SDB 524. The SDM editor 526 sends CRUD SDMs to the core SDB 524. The core SDB 524 sends periodic MD updates to the core MQ 528. Core MQ handlers 530 reads core MQ 528 periodically for MD updates. In response to an MD update at the core MQ 528, the core MQ 528 returns the MD update (e.g., a token, metadata, and or data payload) to the core MQ handlers 530. The core MQ handlers periodically synchronize with a near-core MDS 546 that reads and/or writes the MD updates to RDS 534.

In some implementations, the computer system 502 requests a visual query from a TUA VizService 542. The TUA VizService 542 requests a semantic query from semantic query engine 544. The semantic query engine 544 requests structured query generation from the near-core MDS 546 which returns a generated structured query to the semantic query engine 544. The semantic query engine 544 sends the generated structured query and requests execution of the generated structured query to Hyper 520. Hyper 520 requests structured query analysis from the near-core MDS 546, and the near-core MDS 546 returns an analysis of the generated structured query. Hyper 520 then requests execution of the structured query from VDAL/DAS 548.

In some implementations, authentication, and DC token exchange endpoints 538, connect API 522, core MDS 536, core SDB 524, SDM editor 526, core MQ 528, and core MQ handlers 530 reside in a core 540. In some implementations, the interactive connectors 508, Excel and/or CSV parser 510, BIBS 512, credentials service 516, and DCF staging S3 bucket 514 reside in a DCF 518. In some embodiments, the SFAP 504, TUA VizService 542, semantic query engine 544, near-core MDS 546, RDS 534, Hyper 520, VDAL/DAS 548, DCF 518, and Lakehouse S3 bucket 550 reside in a data cloud FD 504.

### Example Computing Device for Concurrent Metadata and Data Processing

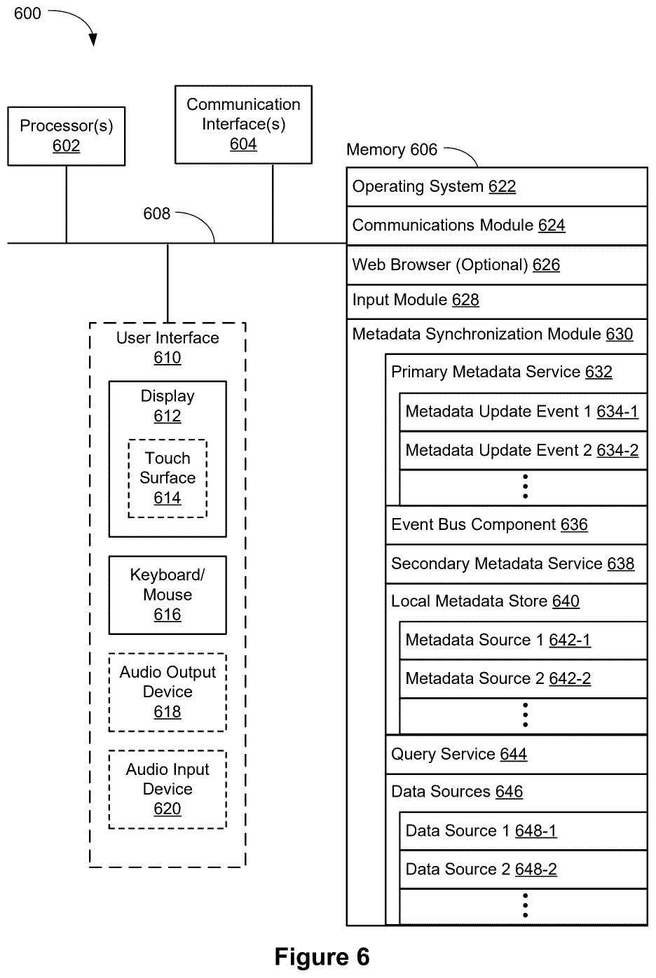

FIG. 6 is a block diagram of an example computing device 600 for concurrent metadata and data processing in interactive data ingestion, according to some implementations. Computing devices 600 include desktop computers, laptop computers, tablet computers, and other computing devices with a display and a processor capable of running a data visualization application. A computing device 600 typically includes one or more processing units/cores (CPUs) 602 for executing modules, programs, and/or instructions stored in the memory 606 and thereby performing processing operations; one or more network or other communications interfaces 604; memory 606; and one or more communication buses 608 for interconnecting these components. The communication buses 608 may include circuitry that interconnects and controls communications between system components. In some implementations, the computing device 600 includes a user interface 610 comprising a display 612, which may include a touch surface or touch screen display 614, and/or one or more input or output devices or mechanisms (e.g., a keyboard/mouse 616, an audio output device 618, and/or an audio input device 620). In some implementations, the display 612 is an integrated part of the computing device 600. In some implementations, the display is a separate display device. The input devices or mechanisms can be used to provide natural language commands directed to data sources 646.

In some implementations, the memory 606 includes high-speed random-access memory, such as DRAM, SRAM, DDR RAM, or other random-access solid-state memory devices. In some implementations, the memory 606 includes non-volatile memory, such as one or more magnetic disk storage devices, optical disk storage devices, flash memory devices, or other non-volatile solid-state storage devices. In some implementations, the memory 606 includes one or more storage devices remotely located from the processors 602. The memory 606, or alternatively the non-volatile memory devices within the memory 606, comprises a non-transitory computer-readable storage medium. In some implementations, the memory 606, or the computer-readable storage medium of the memory 606, stores the following programs, modules, and data structures, or a subset thereof:
an operating system 622, which includes procedures for handling various basic system services and for performing hardware dependent tasks;
a communication module 624, which is used for connecting the computing device 600 to other computers and devices via the one or more communication network interfaces 604 (wired or wireless) and one or more communication networks, such as the Internet, other wide area networks, local area networks, metropolitan area networks, and so on;
an optional web browser 626 (or other client application), which enables a user to communicate over a network with remote computers or devices;
an input module 628 to process input and/or signals received from the user interface 610, and/or output signals to output devices in the user interface 610;
a metadata synchronization module 630, which includes a primary metadata service 632, event bus component 636, secondary metadata service 638, local metadata store 640 (e.g., a first metadata source 642-1), and query service 644. The primary data; and/or
zero or more databases or data sources 646 (e.g., a first data source 638-1), which are used by the module 630. In some implementations, the data sources are stored as spreadsheet files, CSV files, XML files, flat files, JSON files, tables in a relational database, cloud databases, or statistical databases.

The metadata synchronization module 630 can be used to implement the architecture shown in FIG. 1, according to some implementations. Specifically, the primary metadata service 632 corresponds to the primary data service 102 and handles data source discovery, the event bus component 636 corresponds to the event bus component 108 for event propagation, the secondary metadata service 638 with its local metadata store 640 corresponds to the secondary metadata service 112 and local metadata store 114 for maintaining synchronized metadata, and the query service 644 corresponds to the query service 116 to enable rapid data exploration. This correspondence between the modules in the computing device and the architectural blocks shows how the conceptual design can be implemented in practice through specific software components, with each module responsible for its counterpart's functionality in the high-level architecture, according to some implementations.

In addition to the modules and/or data structures described above, the memory 606 stores additional modules and data structures that may be necessary for performing the operations described in reference to FIGS. 1-5, and FIGS. 7 and 8, even if not explicitly described herein. Each of the above identified executable modules, applications, or set of procedures may be stored in any of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 606 stores a subset of the modules and data structures identified above. In some implementations, the memory 606 stores additional modules or data structures not described above. Although FIG. 6 shows a computing device 600, FIG. 6 is intended more as a functional description of the various features that may be present rather than as a structural schematic of the implementations described herein. In practice, and as recognized by those of ordinary skill in the art, items shown separately could be combined and some items could be separated.

Each of the above identified executable modules, applications, or sets of procedures may be stored in one or more of the identified memory devices and corresponds to a set of instructions for performing a function described above. The modules or programs (i.e., sets of instructions) need not be implemented as separate software programs, procedures, or modules, and thus various subsets of these modules may be combined or otherwise re-arranged in various implementations. In some implementations, the memory 606 stores a subset of the modules and data structures identified above. Furthermore, the memory 606 may store additional modules or data structures not described above.

### Example Methods for Concurrent Metadata and Data Processing

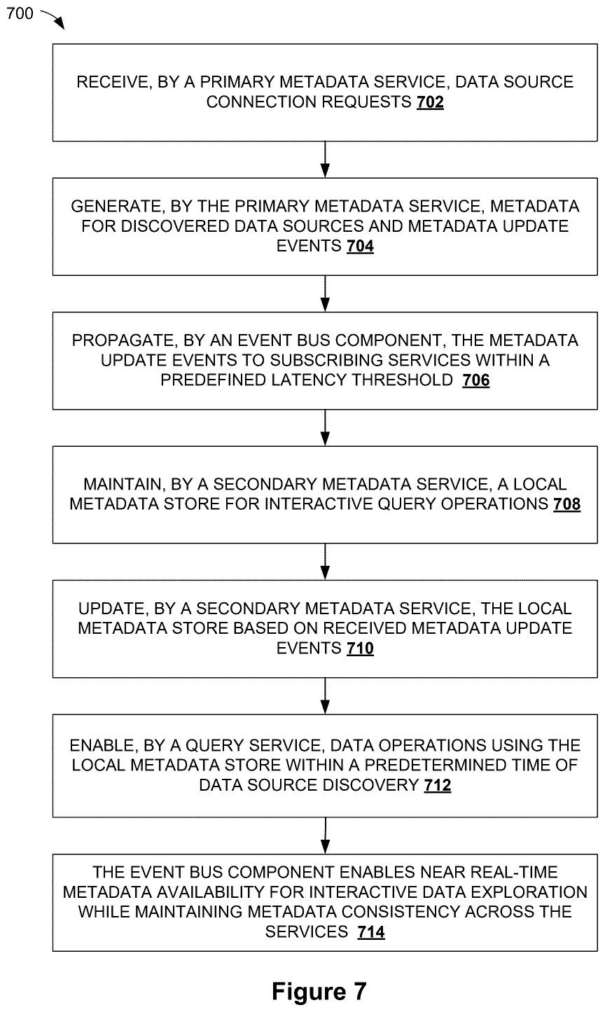

FIG. 7 is a flowchart of an example method 700 for data ingestion, according to some implementations. The method 700 can be performed by a metadata generation and synchronization system (e.g., the system 100) or modules of the computing device 600 described above. A primary metadata service receives (702) data source connection requests.

The primary metadata service 102 receives (702) data source connection requests, generates (704) metadata for discovered data sources, and/or generates (704) metadata update events. In some implementations, the primary metadata service 102 further completes schema inferencing for each table within a predetermined time (e.g., 100 milliseconds). In some implementations, the primary metadata service 102 further processes multiple sheets from spreadsheet files and create separate metadata definitions for each table. In some implementations, the primary metadata service 102 further maintains a single metadata definition with non-parseable status for sheets that fail schema inference. In some implementations, the primary metadata service 102 further creates data stream definitions associated with discovered metadata for data ingestion tracking. In some implementations, the primary metadata service 102 further processes metadata discovery requests using a connection identifier and an optional file identifier for different data source types. In some implementations, the primary metadata service 102 further manages data lake objects, data model objects, and semantic data models as distinct metadata types. In some implementations, the primary data service 102 further validates access using OAuth tokens, the secondary metadata service validates access using claims embedded within data cloud tokens, and the system requires both OAuth token validation for operations of the primary metadata service and claim validation from data cloud tokens for operations of the secondary metadata service. In some implementations, the primary metadata service 102 further manages temporary credentials for accessing data sources during metadata discovery operations. For example, the core MDS 206 provides temporary S3 credentials for a caller to use to perform file uploads directly to a drive bucket, which is used for metadata inference and/or discovery thereafter.

The event bus component 108 propagates (706) the metadata update events to subscribing services within a predefined latency threshold. The event bus component 108 also enables (714) near real-time metadata availability for interactive data exploration while maintaining metadata consistency across the services. In some implementations, the event bus component 108 further guarantees event delivery only for successfully committed metadata transactions.

The secondary metadata service 112 maintains (708) the local metadata store 114 for interactive query operations. The secondary metadata service also updates (710) the local metadata store based on received metadata update events. In some implementations, the secondary metadata service further obtains, receives and/or processes direct metadata updates (e.g., without any processing by the primary metadata service) and maintains draft metadata states prior to synchronization with the primary metadata service. For example, the near-core MDS keeps track of metadata that has not been updated in the core MDS, and atomically switches that metadata from a draft state to a committed state.

The query service 116 enables (712) data exploration operations using the local metadata store 114 within a predetermined time (e.g., 500 milliseconds) of data source discovery. In some implementations, the query service 116 further obtains security filter predicates from the local metadata store for each table referenced in queries. In some implementations, the query service 116 further resolves semantic data models using metadata from the local metadata store.

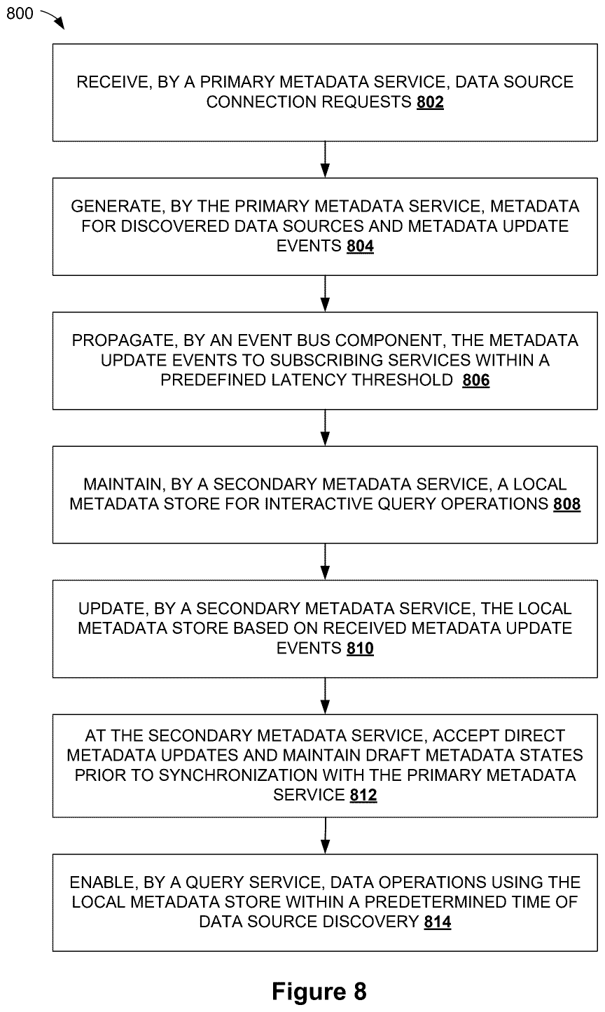

FIG. 8 is a flowchart of another example method 800 for data ingestion, according to some implementations. The method 800 can be performed by a metadata generation and synchronization system (e.g., the system 100) or modules of the computing device 600 described above. A primary metadata service receives (802) data source connection requests.

The primary metadata service 102 receives (802) data source connection requests, generates (804) metadata for discovered data sources, and/or generates (804) metadata update events. In some implementations, the primary metadata service 102 further completes schema inferencing for each table within a predetermined time (e.g., 100 milliseconds). In some implementations, the primary metadata service 102 further processes multiple sheets from spreadsheet files and create separate metadata definitions for each table. In some implementations, the primary metadata service 102 further maintains a single metadata definition with non-parseable status for sheets that fail schema inference. In some implementations, the primary metadata service 102 further creates data stream definitions associated with discovered metadata for data ingestion tracking. In some implementations, the primary metadata service 102 further processes metadata discovery requests using a connection identifier and an optional file identifier for different data source types. In some implementations, the primary metadata service 102 further manages data lake objects, data model objects, and semantic data models as distinct metadata types. In some implementations, the primary data service 102 further validates access using OAuth tokens, the secondary metadata service validates access using claims embedded within data cloud tokens, and the system requires both OAuth token validation for operations of the primary metadata service and claim validation from data cloud tokens for operations of the secondary metadata service. In some implementations, the primary metadata service 102 further manages temporary credentials for accessing data sources during metadata discovery operations. For example, the core MDS 206 provides temporary S3 credentials for a caller to use to perform file uploads directly to a drive bucket, which is used for metadata inference and/or discovery thereafter.

The event bus component 108 propagates (806) the metadata update events to subscribing services within a predefined latency threshold. In some implementations, the event bus component 108 also enables near real-time metadata availability for interactive data exploration while maintaining metadata consistency across the services. In some implementations, the event bus component 108 further guarantees event delivery only for successfully committed metadata transactions.

The secondary metadata service 112 maintains (808) the local metadata store 114 for interactive query operations. The secondary metadata service 112 also updates (810) the local metadata store based on received metadata update events. The secondary metadata service also (812) obtains, receives, and/or processes direct metadata updates (e.g., without processing by the primary metadata service 102) and maintains draft metadata states prior to synchronization with the primary metadata service. For example, the near-core MDS keeps track of metadata that has not been updated in the core MDS, and atomically switches that metadata from a draft state to a committed state.

The query service 116 enables (814) data exploration operations using the local metadata store 114 within a predetermined time (e.g., 500 milliseconds) of data source discovery. In some implementations, the query service 116 further obtains security filter predicates from the local metadata store for each table referenced in queries. In some implementations, the query service 116 further resolves semantic data models using metadata from the local metadata store.

In some implementations, the metadata synchronization system 100 includes a state management component that tracks metadata states including path reserved, commit pending, overwrite success, and overwrite failure. Some implementations use an RDS table for maintaining the states for a DLO. In some implementations, the metadata synchronization system 100 includes a task state machine that tracks metadata discovery and synchronization across system restarts. In some implementations, the system 100 further maintains separate metadata stores for personal exploration workspaces disconnected from main organization metadata. In some implementations, the system 100 further maintains metadata consistency through background synchronization when event-based propagation fails. In some implementations, the system 100 further maintains cross-references between visualizations, semantic models, data lake objects, and data streams for lineage tracking. In some implementations, the system 100 further tracks metadata synchronization status through synchronized state transitions for each table definition. In some implementations, the system 100 further re-runs metadata discovery operations for tasks in a discover state after system restarts. In some implementations, the system 100 further maintains metadata isolation across different organization and tenant boundaries. In some implementations, the system 100 prevents direct service calls during database transactions. In some implementations, the system 100 further includes a connector service (e.g., the interactive connectors 508), which provides schema preview capabilities while metadata discovery is in progress. The connectors service provides applications the ability to infer schema from data sources for which a connector has been integrated. Using this inferred schema, metadata can be created by the application in either the primary metadata store or the secondary metadata store. In some implementations, for interactive data exploration, this metadata can be directly created in the secondary metadata store.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set of time intervals or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A metadata synchronization system, comprising:
a primary metadata service configured to receive data source connection requests, generate metadata for discovered data sources, and generate metadata update events;
an event bus component configured to propagate the metadata update events to subscribing services within a predefined latency threshold;
a secondary metadata service configured to maintain a local metadata store for interactive query operations and update the local metadata store based on received metadata update events; and
a query service configured to enable data exploration operations using the local metadata store within a predetermined time of data source discovery,
wherein the event bus component enables near real-time metadata availability for interactive data exploration while maintaining metadata consistency across the services.

2. The metadata synchronization system of claim 1, wherein the secondary metadata service is further configured to accept direct metadata updates and maintain draft metadata states prior to synchronization with the primary metadata service.

3. The metadata synchronization system of claim 1, further comprising a state management component configured to track metadata states including path reserved, commit pending, overwrite success, and overwrite failure.

4. The metadata synchronization system of claim 1, wherein the primary metadata service is further configured to complete schema inferencing for each table within a predetermined time.

5. The metadata synchronization system of claim 1, wherein the primary metadata service is further configured to process multiple sheets from spreadsheet files and create separate metadata definitions for each table.

6. The metadata synchronization system of claim 1, wherein the primary metadata service is further configured to maintain a single metadata definition with non-parseable status for sheets that fail schema inference.

7. The metadata synchronization system of claim 1, further comprising a task state machine configured to track metadata discovery and synchronization across system restarts.

8. The metadata synchronization system of claim 1, wherein the system is further configured to maintain separate metadata stores for personal exploration workspaces disconnected from main organization metadata.

9. The metadata synchronization system of claim 1, wherein the system is further configured to maintain metadata consistency through background synchronization when event-based propagation fails.

10. The metadata synchronization system of claim 1, wherein the primary metadata service is further configured to create data stream definitions associated with discovered metadata for data ingestion tracking.

11. The metadata synchronization system of claim 1, wherein the query service is further configured to obtain security filter predicates from the local metadata store for each table referenced in queries.

12. The metadata synchronization system of claim 1, wherein the system is further configured to maintain cross-references between visualizations, semantic models, data lake objects, and data streams for lineage tracking.

13. The metadata synchronization system of claim 1, wherein the primary metadata service is further configured to process metadata discovery requests using a connection identifier and an optional file identifier for different data source types.

14. The metadata synchronization system of claim 1, wherein the query service is further configured to resolve semantic data models using metadata from the local metadata store.

15. The metadata synchronization system of claim 1, wherein the primary metadata service is further configured to manage data lake objects, data model objects, and semantic data models as distinct metadata types.

16. The metadata synchronization system of claim 1, wherein the system is configured to re-run metadata discovery operations for tasks in a discover state after system restarts.

17. The metadata synchronization system of claim 1, wherein the secondary metadata service is further configured to provide schema preview capabilities while metadata discovery is in progress.

18. A method for metadata generation and synchronization, comprising:
at a computing device having one or more processors, and memory storing one or more programs configured for execution by the one or more processors:
at a primary metadata service:
receiving data source connection requests, generating metadata for discovered data sources, and generating metadata update events;
at an event bus component:
propagating the metadata update events to subscribing services within a predefined latency threshold;
at a secondary metadata service:
maintaining a local metadata store for interactive query operations;
updating the local metadata store based on received metadata update events; and
obtaining direct metadata updates and maintaining draft metadata states based on the metadata updates, prior to synchronization with the primary metadata service; and
at a query service:
enabling data exploration operations using the local metadata store within a predetermined time.

19. The method of claim 18, wherein the event bus component enables near real-time metadata availability for interactive data exploration while maintaining metadata consistency across the services.

20. A non-transitory computer readable storage medium storing one or more programs, the one or more programs configured for execution by a computing device having one or more processors, and memory, the one or more programs comprising instructions for:
at a primary metadata service:
receiving data source connection requests, generating metadata for discovered data sources, and generating metadata update events;
at an event bus component:
propagating the metadata update events to subscribing services within a predefined latency threshold;
at a secondary metadata service:
maintaining a local metadata store for interactive query operations; and
updating the local metadata store based on received metadata update events; and
at a query service:
enabling data exploration operations using the local metadata store within a predetermined time.
